(19) United States
(12) Patent Application Publication
(10) Pub. No.: US 2026/0310724 A1
(43) Pub. Date: Oct. 8, 2026

(54) TWO LEVEL VECTOR EMBEDDING INDEXING IN VECTOR DATABASES FOR SCALABLE SEMANTIC SEARCH

(71) Applicant: Dell Products L.P., Round Rock, TX (US)

(72) Inventor: Raúl Gracia-Tinedo, Barcelona (ES)

(21) Appl. No.: 19/169,732

(22) Filed: Apr. 3, 2025

(51) Int. Cl. G06F 16/783; G06V 20/40

(52) U.S. Cl. CPC G06F 16/7847; G06V 20/46

(57) ABSTRACT

Techniques for implementing a two-level indexing layout with associated query logic to scale semantic searches in vector databases are disclosed. A service accesses a first video stream and a second video stream. The service generates a first set of vector embeddings for the first video stream and a second set of vector embeddings for the second video stream. The service samples the first set of vector embeddings and the second set of vector embeddings to populate a global sampling index. The service populates a first full local index for the first video stream using the first set of vector embeddings and populates a second full local index for the second video stream using the second set of vector embeddings. In response to a query, the service initially queries the global sampling index and then subsequently queries at least one of the first or second full local indexes.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to improving semantic searches. More particularly, at least some embodiments relate to systems, hardware, software, computer-readable media, and methods for implementing a two-level indexing layout with associated query logic to scale semantic searches in vector databases.

### BACKGROUND

Retrieval Augmented Generation (RAG) has brought the attention back into the custom search engine paradigm. This new structure brought a new set of techniques and algorithms that manage databases, large language model (LLM) contexts, and user intention.

In a RAG system, the quality of the response is predicated on the LLM's capabilities and the quality of the retrieval algorithm. The retrieval algorithm relies on a pre-processing step to move internal data (e.g., such as from presentations, reports, etc.) into a context that is readable by an LLM. During this process, it is common to disperse documents into different databases that can be probed independently during the retrieval process.

However, LLMs have a limited context size, thereby limiting the number of sources that can be used to answer a user question. Furthermore, searching an entire ecosystem of many multiple databases is hardly scalable.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example RAG system.

FIG. 2 illustrates an example computing architecture for implementing a two-level indexing layout with associated query logic to scale semantic searches in vector databases.

FIG. 3 illustrates an example indexing scenario.

FIG. 4 illustrates another example indexing scenario.

FIG. 5 illustrates a chart of various latencies.

FIG. 6 illustrates a table showing the preliminary integration of a data loader.

FIG. 7 illustrates a flowchart of an example method for implementing a two-level indexing layout with associated query logic to scale semantic searches in vector databases.

FIG. 8 illustrates an example computer system that can be configured to perform any of the disclosed operations.

### DETAILED DESCRIPTION

As mentioned previously, RAG is a process that leverages LLMs to generate content given a user query. Relevant attributes for a high quality RAG relate to a high quality retrieval algorithm and a high quality LLM that can take advantage of the algorithm. The retrieval algorithm gathers content from a database and inserts that content into an LLM context (e.g., into an LLM prompt). The LLM can then use the content from the database to answer the query. It should be noted that while a majority of this disclosure is centered around the use of a context for LLMs, the context should be interpreted in a broad manner and should generally include scenarios involving performing semantic search operations. These semantic search operations can be performed using any data type, although this disclosure focuses mainly on video and image data types.

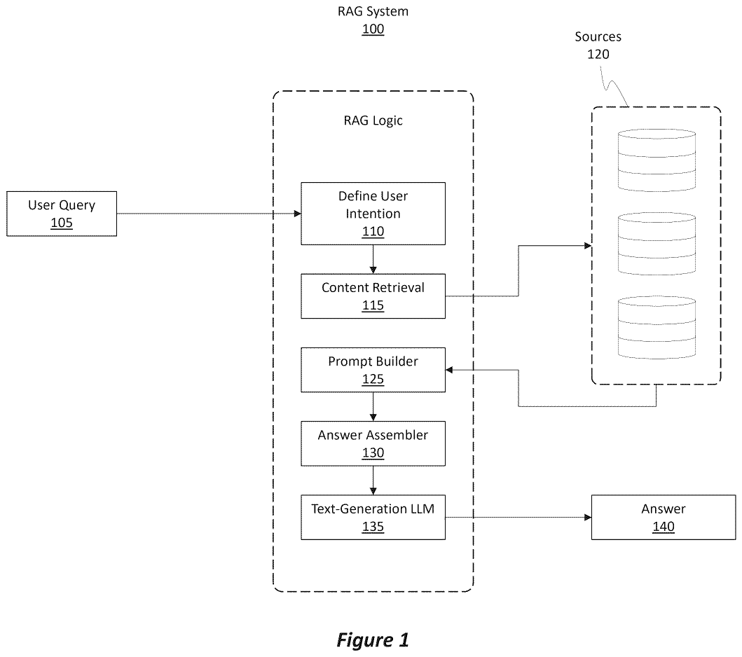

To illustrate, FIG. 1 displays a generic RAG system 100 and its main phases or modules, ranging from receiving a user query 105 to generating an answer. In FIG. 1, the “Define User Intention” module 110 uses the user query 105 to model the rest of the pipeline. Often, these steps involve moderation or the customization of an instruction prompt.

The “Content Retrieval” module 115 then involves querying one, some, or all available sources 120 (e.g., databases) that have pre-processed textual content in a chunk-like manner. These sources 120 are normally vector databases that support a similarity search operation.

The textual content is returned at the “Prompt Builder” module 125. This module identifies the results that are determined to be most relevant with respect to the user's query. Those results will be used to generate a prompt for the LLM. Because of a limited context size dictated by the “Text-generation LLM” module, the disclosed embodiments allow only the highest ranked sources to be inserted into the prompt.

An answer assembler module 130 will use the prompt as input. This module requests an answer from the text-generation LLM 135, which will produce the desired response or answer 140. Additional steps, such as re-ranking or post-processing on the output of the text-generation LLM, can also be included in some renditions of the RAG system 100.

Exploiting vector embeddings (e.g., the RAG system 100 of FIG. 1) is particularly relevant for customer applications running at a network's edge. Normally, vector embeddings are stored and managed via a vector database (DB). Notably, some of the customer applications generating and querying embeddings can induce huge workloads for which an unproperly provisioned vector DB may struggle to cope with. Applications that generate vector embeddings from video frames are both commercially interesting and workload intensive. For instance, in use cases such as health video analytics, it may be desirable to index each video stream with a fine level of granularity (e.g., one embedding per key video frame), given that no frame can be missed due to surgical requirements. As one can infer, this may end up generating a large number of embeddings if thousands of videos are processed for embeddings generation.

For such applications that require huge amounts of embeddings to represent video frames, building a global index for all the videos does not scale well because the amount of required memory per query is, in some cases, the size of the indexed vectors. On the other hand, the cost of querying individual indexes can grow linearly with the number of video streams. Thus, it is desirable to devise an index management approach that provides a reasonable solution to this trade-off.

At least some of the disclosed embodiments provide various solutions to the above problems. In particular, at least some of the embodiments present a two-level mechanism to index and query video frames represented as vector embeddings in vector DBs. First, at indexing time, at least some of the embodiments build a global sampling index for a given inference model processing video frames. That is, a specific subset of embeddings related to relevant video frames from each video stream are stored in the global sampling index.

Second, each video frame may have its own full index in which all the video frames are stored. With these two indexes, at least some of the embodiments can efficiently serve inter-video and intra-video semantic queries.

Inter-video semantic queries exploit the global sampling index to locate video streams with similar sampled content to an input embedding. On the other hand, intra-video queries allow at least some of the embodiments to find the most similar video fragments in a collection of video streams to an input embedding. Notably, the disclosed principles are generic in that at least some of the embodiments can optionally build the two-level index on any vector DB, irrespective of its internal optimization mechanisms, which may vary depending on the system.

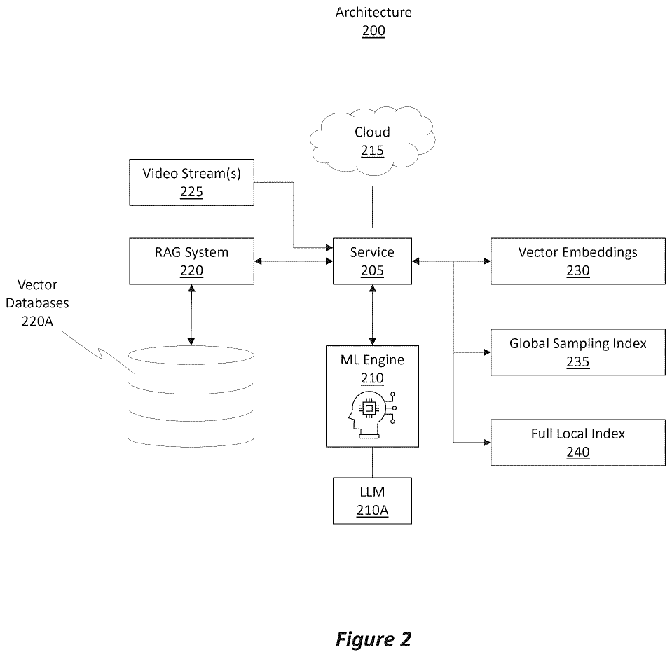

Having just provided some context information and some details regarding some of the benefits and advantages provided by the disclosed embodiments, attention will now be directed to FIG. 2, which illustrates an example architecture 200 in which the disclosed principles may be employed. Architecture 200 shows a service 205.

As used herein, the term “service” refers to an automated program that is tasked with performing different actions based on input. In some cases, service 205 can be a deterministic classifier that operates fully given a set of inputs and without a randomization factor. In other cases, service 205 can be or can include a machine learning (ML) or artificial intelligence engine, such as ML engine 210. The ML engine 210 enables service 205 to operate even when faced with a randomization factor. The ML engine 210 can include or can be associated with a large language model (LLM) 210A. The LLM 210A can be tasked with assisting the service 205 in any of the disclosed operations.

As used herein, reference to any type of machine learning or artificial intelligence (or large language model (LLM)) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 205 is a local service operating on a local device, such as an edge device. In some implementations, service 205 is a cloud service operating in a cloud 215 environment. In some implementations, service 205 is a hybrid service that includes a cloud component operating in cloud 215 and a local component operating on a local device. These two components can communicate with one another.

Service 205 is generally tasked with improving applications requiring RAG-like services, such as the RAG system 220, which includes or has access to the vector databases 220A. The vector databases 220A correspond to the source 120 of FIG. 1.

Vector DBs are specialized systems designed to manage and query high-dimensional vector data efficiently. These databases are beneficial for artificial intelligence (AI) and machine learning (ML) applications, where data is often represented as vectors or embeddings. Vector DBs enable fast and scalable similarity searches, which are beneficial for tasks such as image retrieval, recommendation systems, and natural language processing.

By storing data in vector form, these databases can leverage advanced indexing techniques to perform quick nearest neighbor searches. Embeddings play a beneficial role in vector databases, serving as the numerical representation of data objects in a continuous vector space. These embeddings are generated using machine learning models that transform complex data types, such as images or text, into fixed-length vectors that capture the intrinsic features of the original data. For instance, image embeddings translate visual content into vectors that reflect visual similarity. This transformation allows for efficient comparison and retrieval of similar items based on their vector representations.

As one non-limiting example, this disclosure will focus on an example video streaming application that needs semantic search capabilities on video frames. It can be assumed that there is a streaming system taking care of video input/output (I/O) and that applications and artificial intelligence (AI) models can manipulate the video at the frame level. Service 205 is tasked with building a two-level video stream indexing layout per embeddings model for semantic search purposes. Further details on the above example will be provided later.

Service 205 implements an indexing instance that manages running an AI inference model, which can be included as a part of the ML engine 210. The indexing instance includes the low-level implementation wiring from reading video frames from a streaming system. Moreover, it exposes clear application programming interfaces (APIs) for serving a user-provided AI inference model with video frames to be processed.

Service 205, and more specifically the AI model, obtains a video frame as input and generates a set of vector embeddings 230. After the set of vector embeddings 230 is generated, service 205 outputs the vector embedding with the original video frame back to the indexing instance API.

One objective of the indexing instance is to populate a global sampling index 235. The global sampling index 235 includes a subset of the vector embeddings 230 for the videos in the system associated to the video stream. The global sampling index 235 enables service 205 to quickly and efficiently search for videos in which any sampled frame satisfies a similarity query.

The indexing instance can accommodate different sampling algorithms that populate the global sampling index 235. Service 205 considers one or more simple sampling algorithms, such as time-based index sampling (e.g., index a frame every 1 or 30 minutes) as well as more sophisticated “shot boundary” algorithms. Non-time based sampling algorithms can be used as well, such as acquiring a sample every “X” number of frames in a periodic manner. Another non-time based sampling technique relates to sampling one frame for each unique scene in the video stream. Regarding the time-based index sampling, any sampling rate can be used, such as the one mentioned above. Another sampling rate can be any value from about 10 seconds to about 30 minutes.

Moreover, an indexing instance also builds a full local index 240 for each individual stream. In one example scenario, one embedding can be generated for each frame in the video stream. Thus, if the video stream(s) 225 include five different streams, a full local index is generated for each one of the five streams, and these full local indexes describe the streams in a highly granular and comprehensive manner. In contrast, the global sampling index 235 includes samples of video streams and is not nearly as robust. In some cases, the number of vector embeddings included in the global sampling index is a relatively small percentage of the number of vector embeddings included in one, some, or all of the full local indexes. For instance, the number of vector embeddings included in the global sampling index may be any percentage value (relative to one or a combination of the full local indexes) ranging from about 1% to about 50%, or any value therebetween.

The per video stream/AI model pair full local index 240 associates vector embeddings with video frame offsets and positions in a data stream, so video fragment data can be retrieved with a high level of precision. The outcome of the embeddings model running in the indexing instance is written to the vector DB without user intervention.

Based on the generated indexes, service 205 allows users to perform two types of semantic queries: inter-video and intra-video. On the one hand, inter-video queries use the sampling embeddings index for the given embeddings model and enable users to find video streams in which any sampled frame matches the similarity criterion. On the other hand, intra-video queries allow users to find fragments or specific frames within a video stream that match the similarity criterion.

Additionally, service 205 abstracts users from vector DB interactions so they can perform semantic searches using images as input and to visualize the results, thereby simplifying the user's experience. Thus, the disclosed two-level video indexing layout trades off a small storage penalty in which the global sampling index is built (e.g., 1% to 5% additional vector embeddings depending on the sampling model) for better semantic query scalability.

Thus, in some embodiments, service 205 accesses a first video stream and a second video stream. Service 205 then generates a first set of vector embeddings for the first video stream. Notably, the first set of vector embeddings includes a corresponding vector embedding for each frame in the first video stream. Service 205 also generates a second set of vector embeddings for the second video stream. Similarly, the second set of vector embeddings includes a corresponding vector embedding for each frame in the second video stream.

Service 205 samples the first set of vector embeddings and the second set of vector embeddings to populate a global sampling index. The global sampling index includes some, but not all, of the vector embeddings included in the first set of vector embeddings and the vector embeddings included in the second set of vector embeddings.

Service 205 populates a first full local index for the first video stream using the first set of vector embeddings. Relatedly, service 205 populates a second full local index for the second video stream using the second set of vector embeddings.

In response to a query, service 205 initially queries the global sampling index by performing an inter-video query. Subsequently, service 205 queries at least one of the first full local index and the second full local index based on a result of initially querying the global sampling index by performing an intra-video query.

Referring back to the earlier example, the National Center for Tumor Diseases (NCT) is an institution that involves data scientists and surgeons who apply AI techniques using surgery-related multimedia. NCT requires video data from surgery cameras to be durably ingested and processed in real time via specialized AI inference models to help surgeons during the procedure. Moreover, video data should be durably stored in long-term storage, so it can be accessed via batch analytics (e.g., AI model training).

A new, challenging requirement for NCT is to search for specific video fragments, or even individual frames, in a collection of video streams. This is required for multiple reasons, ranging from the creation of specialized AI model training datasets to help surgeons or medical students locating specific video fragments of certain anatomies. If a large collection of video streams is considered, using just the metadata of video streams is not enough to satisfy content-based queries. Moreover, data scientists may require finding videos based on unstructured data as input, such as an image. It is desirable to have a content-based approach for indexing, querying, and retrieving relevant video stream data in streaming systems. The disclosed embodiments provide such an approach.

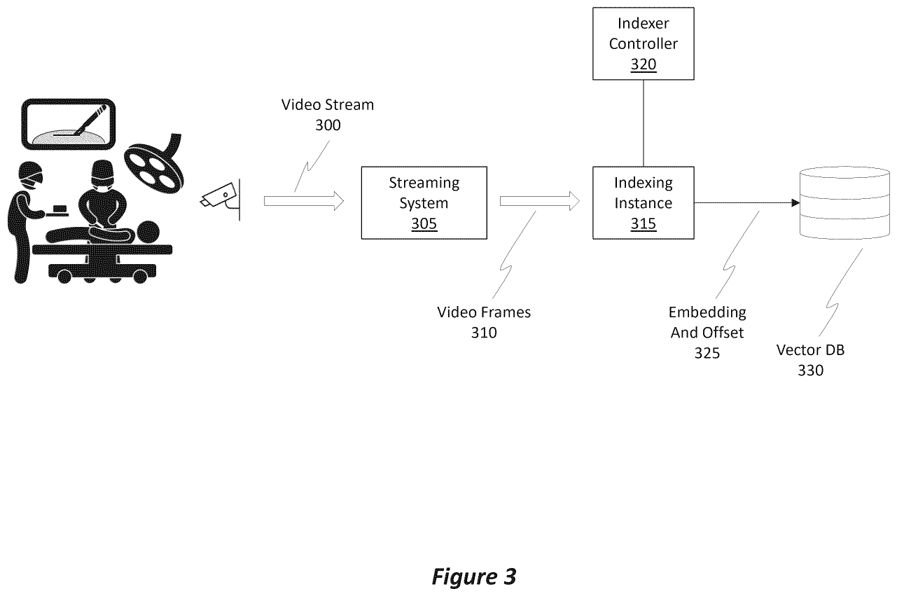

FIG. 3 shows one example use case scenario involving the disclosed operations. As mentioned earlier, service 205 of FIG. 2 is tasked with indexing video frames as embeddings in a two-level layout for semantic query scalability.

FIG. 3 initially shows a video ingestion phase, as shown by the generation and transmission of the video stream 300 to the streaming system 305. In this example, video frames from multiple surgery cameras are ingested in the streaming system video stream 300. The streaming system 305 then provides the video frames 310 of the video stream 300 to the indexing instance 315, which includes an indexer controller 320. The indexer controller 320 can be included as a part of service 205.

The indexer controller 320 (and hence service 205) includes logic for running indexing instances and for replying to user semantic queries. First, service 205 considers an indexing container image that handles I/O with the streaming system 305 and includes the necessary dependencies. Service 205 can create a new indexing instance 315 using the indexing container image with the appropriate AI model from the model registry (i.e., repository of embeddings models on top of the indexing container image). The indexing container image ingests the video frames 310, passes them through the AI model, and writes the index data in the vector DB 330. That is, the index data includes an embedding for the video frame and an offset of the video frame (i.e. a position of the video frame within the stream as a whole), as shown by embedding and offset 325.

In health use-cases (e.g., NCT), every frame may contain critical information pertaining to surgical events, such as serious complications. Missing video frames could result in overlooking vital details, which drives the motivation to generate and store the full local index 240 from FIG. 2. However, while vector DBs can create indexes over large vector embeddings collections, performing efficient queries on a single index containing all the video embeddings can be challenging.

For example, vector DBs can be limited in their query capabilities to the amount of available memory. On the other hand, just creating an index per video stream and embeddings model can be problematic as well. Because each query can only access one video stream index, the cost of searching for content can grow in the order of the number of video stream indexes. This is an interesting trade-off that calls for a vector DB-agnostic solution.

Advantageously, service 205 builds a two-level video stream indexing layout per embeddings model. First, indexing instances run an indexing sampling algorithm. As mentioned previously, some embodiments consider simple sampling algorithms such as time-based index sampling (e.g., index a frame every 1 or 30 minutes) as well as more sophisticated “shot boundary” algorithms.

The index sampling algorithm determines the embeddings that will be stored in the global sampling index. The global sampling index will include a small set of embeddings for all the videos in the video stream. The global sampling index enables service 205 to search for videos in which any sampled frame satisfies a semantic query.

The indexing instance also builds a full local index for the stream at hand (e.g., one embedding per key frame). The outcome of the embeddings model running in the indexing instance is written to the vector DB. With this full local index, service 205 can perform fine-grained search on any video stream. This is beneficial for finding relevant video fragments given a specific similarity criterion.

The indexer controller also handles orchestrating the query workflow. First, it receives the input data for the query at hand. There are two types of input data to consider, namely, vector embeddings and images. In the former, the provided embedding is directly used to perform the similarity search against the vector DB. For the latter, the indexer controller first generates the embedding from the input image and then performs the similarity search.

Based on the generated indexes, service 205 allows users to perform two types of queries: inter-video and intra-video. Queries target the index generated from the embeddings model m. Below is an example of an inter-video query example.

For example, consider the following command: GET k STREAMS FROM f FRAMES x % LIKE [IMAGE] USE EMBEDDINGS MODEL m. Here, inter-video queries use the sampling embeddings index (i.e. the full local index) for the given embeddings model and enable users to find video streams in which any (sampled) frame matches the similarity criterion. Inter-video queries expose four parameters to users: i) the maximum number of video streams to return to the user (k), ii) the number of closest sample frames to retrieve from the vector DB (f), iii) the similarity threshold or percentage required for result video streams (x), and iv) the embeddings model (m). The query workflow involves retrieving (e.g., from the full local index for model m) the top k·f sample frame embeddings most similar to the input embedding. Service 205 can filter out the embeddings that do not meet the similarity threshold x for retrieving the relevant best k streams.

Intra-video queries allow users to find fragments within a video stream that match the similarity criterion. Below is an example query.

For example, consider the following command: FROM k STREAMS GET f FRAGMENTS WITH FRAMES x % LIKE [IMAGE] FRAGMENT_LENGTH t USE EMBEDDINGS MODEL m. Here, the query workflow works in two steps. First, the indexer controller runs an inter-video query (e.g., against the global sampling index) with the input embedding to retrieve the most similar k video stream candidates and discards the ones not respecting the similarity threshold x. Then, with the resulting video stream collection, the indexer controller will search the specific video stream full indexes (i.e. the full local indexes) for the f most similar frames (e.g., described by <embedding: frame_id:offset>triples) to the input image reference. For each video stream, the query filters the <embedding: frame_id:offset>triples with an accuracy that meets the embedding similarity threshold x.

The length of the video fragment surrounding a relevant frame is determined by the query parameter t (e.g., 20 seconds). The cost in terms of vector DB queries of this process is 1 query to the sampling embeddings index and up to k queries to find frames to the individual video stream full indexes, which can be parallelized for better performance. Note that it may be the case for several relevant frames to be consecutive in a video stream. To minimize redundant results, video fragments with overlapping offsets are merged into a single one.

Both inter/intra-video queries are exposed via APIs in the indexer controller (i.e., find_streams(image, k, f, x, m) and find_fragments(image, k, f, x, t, m)). This enables external programs to exploit the semantic video search in our invention. This process allows users to easily find and load relevant training datasets, while reducing data transfers during the process.

Finally, the indexer controller obtains the video stream names or video fragments offsets from a query and facilitates the display of the query results. At least some of the embodiments also consider providing facilities for visualizing the outcomes of queries, thus providing a full end-to-end solution for semantic video search.

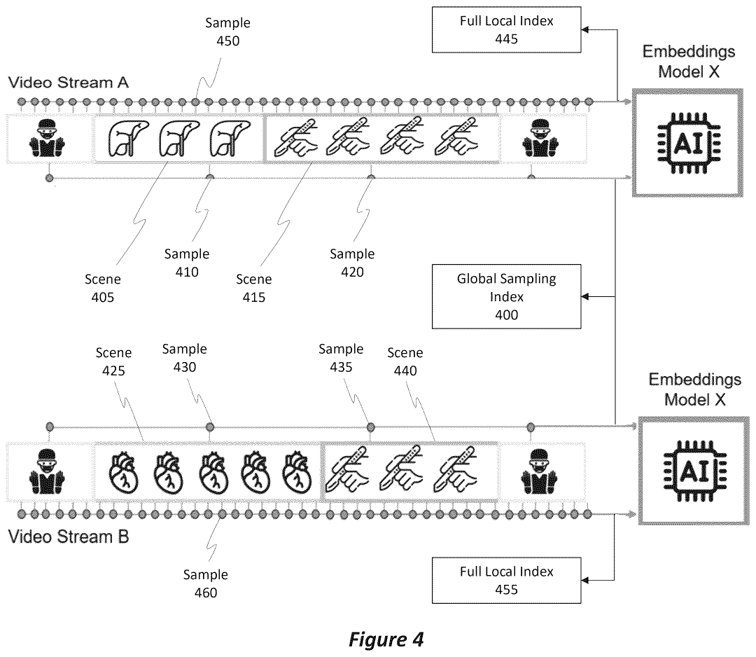

For instance, consider the scenario presented in FIG. 4. Here, there are two video streams, namely video stream A and video stream B. In accordance with the disclosed principles, a global sampling index 400 is generating by accessing the video streams A and B. Service 205 of FIG. 2 can analyze the two different streams and detect a scene change. The term “scene” generally refers to a set of one or more frames that share a common level of similarity to one another. For instance, scene 405 in FIG. 4 includes frames of a specific human organ. In contrast, scene 415 include frames of a surgeon's hand using a scalpel. Similarly, scene 425 includes frames of a different human organ, and scene 440 includes frames of the surgeon's hand using a scalpel.

The global sampling index 400 is generating, in this example, by sampling one frame from each scene in the video streams. For instance, sample 410 is obtained from scene 405, sample 420 is obtained from scene 415, sample 430 is obtained from scene 425, and sample 435 is obtained from scene 440. The samples 410, 420, 430, and 435 are formatted in the embedding data structure and then included in the global sampling index 400. Thus, the global sampling index 400 can include samples from multiple disparate video streams.

In contrast, the full local index 445 is generated only for video stream A while the full local index 455 is generated only for video stream B. The full local index 445 for video stream A includes samples (e.g., sample 450) for each frame. That is, each frame is converted to an embedding and included in the full local index 445. Similarly, the samples from video stream B (e.g., sample 460) are embedded and included in the full local index 455.

When a user submits a query, the query is first executed against the global sampling index 400. The result of the query is an identification of the video stream that includes one or more frames having content within a threshold level of similarity to the query parameters. After the results from the first query are obtained, the embodiments can query the corresponding full local indexes for the identified video streams. The relevant frame or collection of frames from those video streams can then be identified and provided to the user in the form of a response.

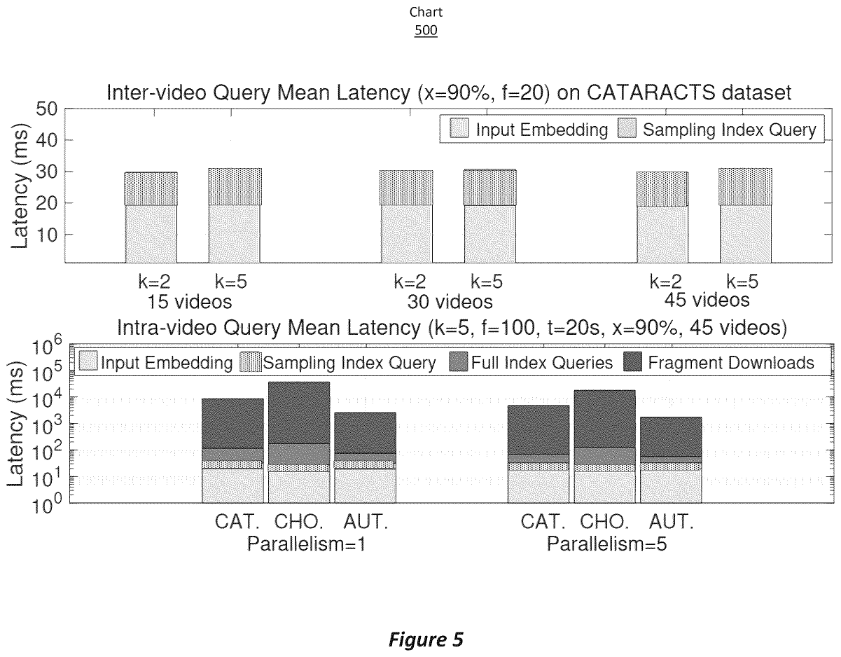

FIG. 5 shows an example chart 500 illustrating the semantic video search latency. Here, the latency of inter/intra video queries are evaluated. In FIG. 5, the upper plot shows the latency of querying the stream sampling index to find streams (k=2, k=5) whose sampled frames meet a certain similarity threshold (x=90%) for various dataset sizes. Visibly, neither the tested number of streams to retrieve (k) nor the tested dataset sizes (15 GB to 50 GB) seem to have an impact on mean query latency, which is around 30 ms. Most of the inter-video query time is spent on generating the input image embedding (≈19 ms), whereas 3-4 ms are related to the query and the rest to filtering query results. This is mainly because the sampling index grows slowly, as the sampling interval is set to 30 seconds. In some scenarios, it was found that the sampling index exhibits similarity search latency >15 ms with 0.5 million embeddings. With the same sampling interval, that would allow for the storage of 4.2 k video hours before sampling index queries take two-digit milliseconds.

The lower plot in FIG. 5 shows the intra-query latency per dataset downloading f=100 video fragments of t=20 seconds from the top k=5 video streams that meet a x=90% similarity. As expected, depending on the dataset, >98% of query time is related to downloading video fragments. This is reasonable as the amount of data to be downloaded ranges from 6 MBs to 160 MBs. Still, it is observed that increasing query parallelism from 1 to 5 threads reduces intra-video query execution in 32% to 51%.

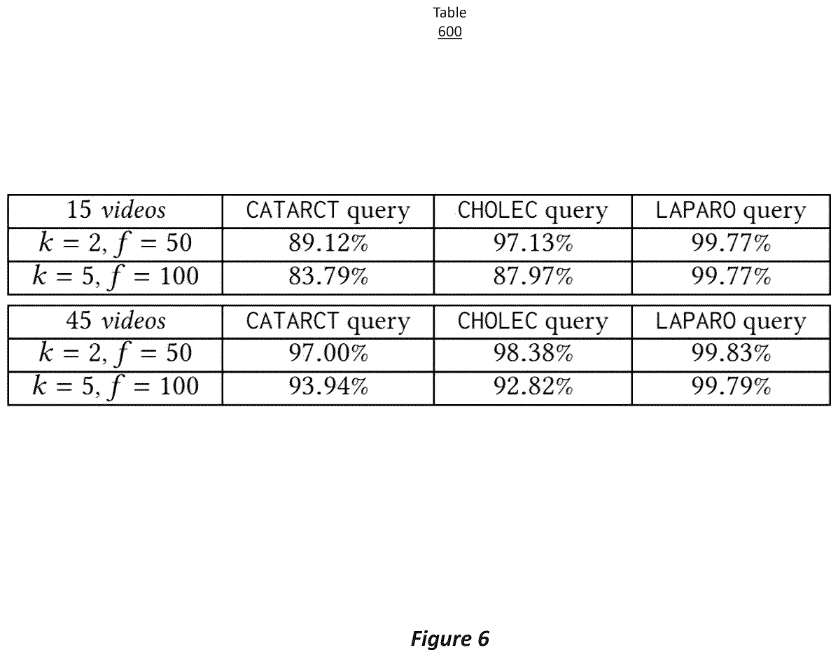

The embodiments also achieve data transfer savings in AI data loading. Here, at least some of the embodiments address the problem of data scientists downloading relevant video data for training their AI models. In table 600 of FIG. 6, some of the embodiments exercise the preliminary integration of a data loader. This configuration allows the data loader to use an embedding as input, as well as the other intra-video query parameters, to download similar video fragments. As can be observed, at least some of the embodiments allow data scientists to automatically load relevant data for training their AI models while achieving a transfer reduction from 83.79% up to 99.83% compared to bulk transferring the whole dataset, depending on the intra-video query parameters (k and f) and the dataset.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

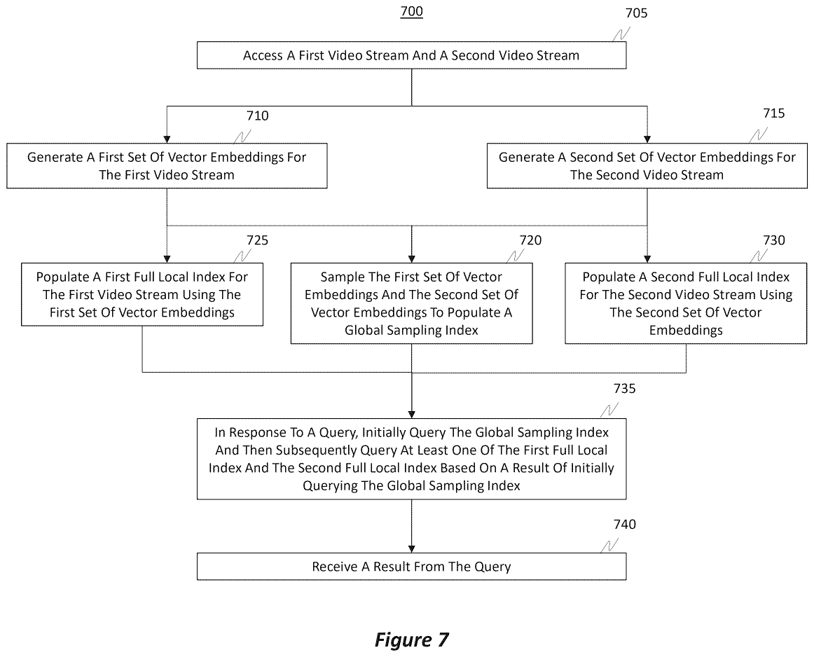

Attention will now be directed to FIG. 7, which illustrates a flowchart of an example method 700 implementing a two-level indexing layout with associated query logic to scale semantic searches in vector databases. Method 700 can be implemented within architecture 200 of FIG. 2. Method 700 can be performed by service 205.

Method 700 includes an act (act 705) of accessing a first video stream and a second video stream. For instance, the video stream(s) 225 of FIG. 2 may include the first and second video streams as well as any number of other video streams.

Act 710 includes generating a first set of vector embeddings for the first video stream. Notably, the first set of vector embeddings includes a corresponding vector embedding for each frame in the first video stream. Similarly, act 715 includes generating a second set of vector embeddings for the second video stream. The second set of vector embeddings includes a corresponding vector embedding for each frame in the second video stream.

Act 720 includes sampling the first set of vector embeddings and the second set of vector embeddings to populate a global sampling index. The global sampling index includes some, but not all, of the vector embeddings included in the first set of vector embeddings and the vector embeddings included in the second set of vector embeddings.

In some embodiments, sampling the first set of vector embeddings and the second set of vector embeddings is performed using a time-based index sampling algorithm. In some embodiments, sampling the first set of vector embeddings and the second set of vector embeddings is performed using a non-time based sampling algorithm. In some embodiments, sampling the first set of vector embeddings and the second set of vector embeddings is performed using a shot boundary sampling algorithm. In some embodiments, sampling the first set of vector embeddings and the second set of vector embeddings is performed by sampling one frame per each respective scene in the first video stream and one frame per each respective scene in the second video stream. In some embodiments, sampling the first set of vector embeddings and the second set of vector embeddings is performed by repeatedly sampling one frame out of a predetermined number of frames in a periodic manner (e.g., one frame for every “X” number of frames).

As one option, a number of vector embeddings included in the global sampling index is less than 50% of a number of vector embeddings included in a combination of the first full local index and the second full local index. As another option, a number of vector embeddings included in the global sampling index is less than 25% of a number of vector embeddings included in a combination of the first full local index and the second full local index. As another option, a number of vector embeddings included in the global sampling index is less than 50% of a number of vector embeddings included in the first full local index. As another option, a number of vector embeddings included in the global sampling index is less than 50% of a number of vector embeddings included in the second full local index. As another option, a number of vector embeddings included in the global sampling index is less than 25% of a number of vector embeddings included in either one of the first full local index or the second full local index. As another option, a number of vector embeddings included in the global sampling index is less than 10% of a number of vector embeddings included in a combination of the first full local index and the second full local index. The number may be within a range of numbers spanning from 1% to 50%, including any number therebetween.

Act 725 includes populating a first full local index for the first video stream using the first set of vector embeddings. Similarly, act 730 includes populating a second full local index for the second video stream using the second set of vector embeddings.

In response to a query, act 735 includes initially querying the global sampling index and then subsequently querying at least one of the first full local index and the second full local index based on a result of initially querying the global sampling index. Stated differently, in response to a query, service 205 triggers an inter-video query against the global sampling index. In response to receiving a result of the inter-video query, service 205 triggers an intra-video query against one or both of the first full local index and the second full local index. Thus, in some embodiments, the query triggers an inter-video query against the global sampling index and an intra-video query against at least one of the first full local index and the second full local index. Typically, the query will include a similarity criterion, and the results of the query identify one or more frames from one or both of the first and second video frames, where those identified frames are determined to satisfy the similarity criterion. Act 740 then includes receiving a result from the query. Notably, the result includes one or more frames that are identified from the at least one of the first full local index or the second full local index.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, classifiers, and component are examples of terms that may refer to software objects or routines that execute on the computing system. The different components, modules, engines, services, and classifiers described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

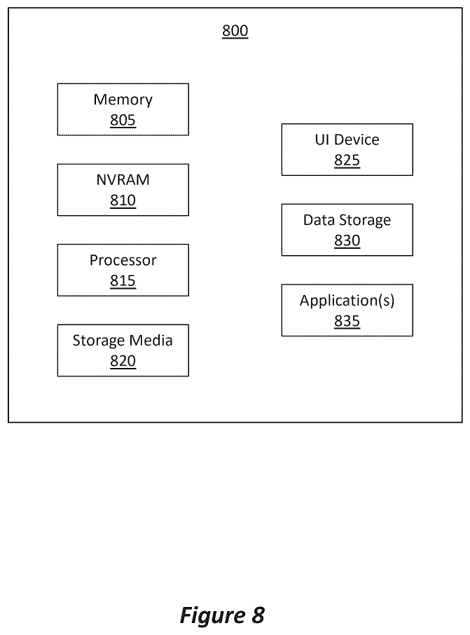

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. This example device can be implemented in architecture 200 of FIG. 2 and can host service 205. Also, where any of the aforementioned elements comprise or consist of a virtual machine (VM), that VM may constitute a virtualization of any combination of the physical components disclosed in FIG. 8.

In the example of FIG. 8, the physical computing device 800 includes a memory 805 which may include one, some, or all, of random access memory (RAM), non-volatile memory (NVM) 810 such as NVRAM for example, read-only memory (ROM), and persistent memory, one or more hardware processors 815, non-transitory storage media 820, UI device 825, and data storage 830. One or more of memory 805 of the physical computing device 800 may take the form of solid-state device (SSD) storage. Also, one or more applications 835 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 800 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
accessing a first video stream and a second video stream;
generating a first set of vector embeddings for the first video stream, wherein the first set of vector embeddings includes a corresponding vector embedding for each frame in the first video stream;
generating a second set of vector embeddings for the second video stream, wherein the second set of vector embeddings includes a corresponding vector embedding for each frame in the second video stream;
sampling the first set of vector embeddings and the second set of vector embeddings to populate a global sampling index, wherein the global sampling index includes some, but not all, of the vector embeddings included in the first set of vector embeddings and the vector embeddings included in the second set of vector embeddings;
populating a first full local index for the first video stream using the first set of vector embeddings;
populating a second full local index for the second video stream using the second set of vector embeddings;
in response to a query, initially querying the global sampling index and then subsequently querying at least one of the first full local index and the second full local index based on a result of initially querying the global sampling index; and
receiving a result from the query, wherein the result includes one or more frames that are identified from the at least one of the first full local index or the second full local index.

2. The method of claim 1, wherein sampling the first set of vector embeddings and the second set of vector embeddings is performed using a time-based index sampling algorithm.

3. The method of claim 1, wherein sampling the first set of vector embeddings and the second set of vector embeddings is performed using a shot boundary sampling algorithm.

4. The method of claim 1, wherein a number of vector embeddings included in the global sampling index is less than 50% of a number of vector embeddings included in a combination of the first full local index and the second full local index.

5. The method of claim 1, wherein a number of vector embeddings included in the global sampling index is less than 25% of a number of vector embeddings included in a combination of the first full local index and the second full local index.

6. The method of claim 1, wherein a number of vector embeddings included in the global sampling index is less than 50% of a number of vector embeddings included in the first full local index.

7. The method of claim 1, wherein a number of vector embeddings included in the global sampling index is less than 50% of a number of vector embeddings included in the second full local index.

8. The method of claim 1, wherein a number of vector embeddings included in the global sampling index is less than 25% of a number of vector embeddings included in either one of the first full local index or the second full local index.

9. The method of claim 1, wherein sampling the first set of vector embeddings and the second set of vector embeddings is performed by sampling one frame per each respective scene in the first video stream and one frame per each respective scene in the second video stream.

10. The method of claim 1, wherein said query triggers an inter-video query against the global sampling index and an intra-video query against said at least one of the first full local index and the second full local index.

11. A method comprising:
accessing a first video stream and a second video stream;
generating a first set of vector embeddings for the first video stream, wherein the first set of vector embeddings includes a corresponding vector embedding for each frame in the first video stream;
generating a second set of vector embeddings for the second video stream, wherein the second set of vector embeddings includes a corresponding vector embedding for each frame in the second video stream;
sampling the first set of vector embeddings and the second set of vector embeddings to populate a global sampling index, wherein the global sampling index includes some, but not all, of the vector embeddings included in the first set of vector embeddings and the vector embeddings included in the second set of vector embeddings;
populating a first full local index for the first video stream using the first set of vector embeddings;
populating a second full local index for the second video stream using the second set of vector embeddings;
in response to a query, triggering an inter-video query against the global sampling index; and
in response to receiving a result of the inter-video query, triggering an intra-video query against one or both of the first full local index and the second full local index.

12. The method of claim 11, wherein sampling the first set of vector embeddings and the second set of vector embeddings is performed using a non-time based sampling algorithm.

13. The method of claim 11, wherein sampling the first set of vector embeddings and the second set of vector embeddings is performed by repeatedly sampling one frame out of a predetermined number of frames in a periodic manner.

14. The method of claim 11, wherein the query includes a similarity criterion.

15. The method of claim 11, wherein sampling the first set of vector embeddings and the second set of vector embeddings is performed using one of a time-based index sampling algorithm or a shot boundary sampling algorithm.

16. The method of claim 11, wherein a number of vector embeddings included in the global sampling index is less than 10% of a number of vector embeddings included in a combination of the first full local index and the second full local index.

17. The method of claim 11, wherein sampling the first set of vector embeddings and the second set of vector embeddings is performed by sampling one frame per each respective scene in the first video stream and one frame per each respective scene in the second video stream.

18. The method of claim 11, wherein a number of vector embeddings included in the global sampling index is less than 50% of a number of vector embeddings included in the first full local index.

19. The method of claim 11, wherein a number of vector embeddings included in the global sampling index is less than 50% of a number of vector embeddings included in the second full local index.

20. A computer system comprising:
one or more processors; and
one or more hardware storage devices that store instructions that are executable by the one or more processors to cause the computer system to:
access a first video stream and a second video stream;
generate a first set of vector embeddings for the first video stream, wherein the first set of vector embeddings includes a corresponding vector embedding for each frame in the first video stream;
generate a second set of vector embeddings for the second video stream, wherein the second set of vector embeddings includes a corresponding vector embedding for each frame in the second video stream;
sample the first set of vector embeddings and the second set of vector embeddings to populate a global sampling index, wherein the global sampling index includes some, but not all, of the vector embeddings included in the first set of vector embeddings and the vector embeddings included in the second set of vector embeddings;
populate a first full local index for the first video stream using the first set of vector embeddings;
populate a second full local index for the second video stream using the second set of vector embeddings;
in response to a query, trigger an inter-video query against the global sampling index; and
in response to receiving a result of the inter-video query, trigger an intra-video query against one or both of the first full local index and the second full local index.
